(19) United States
(12) Patent Application Publication
(10) Pub. No.: US 2004/0016000 A1
(43) Pub. Date: Jan. 22, 2004

(54) Video streaming having controlled quality assurance over best-effort networks

(76) Inventors: Zhi-Li Zhang, Minneapolis, MN (US); Yingfei Dong, Honolulu, HI (US)

Correspondence Address: SHUMAKER & SIEFFERT, P. A., 8425 SEASONS PARKWAY, SUITE 105, ST. PAUL, MN, 55125, US

(21) Appl. No.: 10/421,657

(22) Filed: Apr. 22, 2003

Related U.S. Application Data
(60) Provisional application No. 60/375,476, filed on Apr. 23, 2002.

(51) Int. Cl. H04N 7/16; H04N 7/173

(52) U.S. Cl. 725/143; 725/105

(57) ABSTRACT

In general, a proxy-assisted staggered two-flow video streaming technique is described that provides controlled service assurance for individual videos delivered across a wide-area best-effort network. A server partitions an encoded video into an “essential” part and an “enhanced” part. The essential part includes video frames that have been encoded independently from the other frames of the video. The enhanced part includes video frames that have been encoded in a dependent fashion based on the other frames. A proxy server coupled to the server via a network, wherein the server delivers the essential part of the encoded video to the proxy server using a reliable network protocol, and the second part of the encoded video using an unreliable network protocol. The proxy server merges the essential part and the enhanced part to form a merged video stream, and delivers the merged video stream to a client device.

This application claims priority from U.S. Provisional Application Serial No. 60/375,476, filed Apr. 23, 2002, the entire content of which is incorporated herein by reference.

### TECHNICAL FIELD

The invention relates to computer networks and, more particular, to streaming video across computer networks.

### BACKGROUND

Video streaming across wide-area networks is an important component of emerging global multimedia content distribution networks. To that end, proxy-assisted video delivery systems have been developed in both the research community and industry. At the core of a typical proxy video distribution system resides one or more central video servers that provide access to a large video repository. A collection of video proxy servers is strategically placed within the network infrastructure. These proxy servers assist the central servers in the distribution of stored videos to a large number of end users geographically dispersed at various local access networks.

Proxy-assisted video streaming systems offer several important advantages. Proxy servers can exploit their processing and buffering capabilities to provide network-wide video streaming and media control along the distribution tree in a coordinated but distributed manner. They can also utilize their potentially large disk storage space to prefetch/cache video data, thereby significantly reducing the network resource requirements placed on the network. Furthermore, because of their strategic positions, proxy servers can take into account both the constraints of the underlying network environments as well as application-specific information in optimizing video transmission. Likewise, proxy servers can also leverage information about client end system constraints and Quality of Service (QoS) requirements to deliver video of diverse quality to clients.

Despite these important advantages, the design of proxy video stream systems faces some unique challenges. Although a proxy server provides additional disk space for caching or storing videos, it is still limited relative to the huge volume of videos. As a result, many videos, either in their entirety or in part, nevertheless have to be streamed across the network from the central server.

Moreover, because of the stringent timing constraints in video streaming, it is often important to ensure continuous playback of videos for end users so as to provide consistent and smooth quality. This problem is particularly challenging when videos are streamed across a wide-area “best-effort” network, where the availability of network resources often fluctuates. One technique for addressing this problem utilizes a VPN pipe between the proxy server and the central server. In a typical VPN pipe, the aggregate bandwidth between the two servers is assured; however, for the delivery of individual videos (or packets), no fine-grain delay or bandwidth guarantee is provided due to the best-effort nature of the network. Hence, one design issue in building a wide-area video streaming system is how to provide quality assurance on best-effort networks.

### SUMMARY

In general, a proxy-assisted staggered two-flow video streaming technique is described that provides controlled service assurance for individual videos delivered across a wide-area best-effort network. Utilizing priority structures in an encoded video, e.g., an inter-frame dependence, the techniques partition the video into an “essential” part that is reliably prefetched via a VPN pipe and cached at a proxy server, and an “enhanced” part that is unreliably transmitted in real time via the same VPN pipe.

As described, the techniques define the “essential” part of a requested video to include encoded frames that are encoded independent of other video frames of the sequence. In contrast, the techniques define the “enhanced” part of the requested video to include frames that are encoded based on other frames of the video sequence, e.g., as difference values from other frames.

This disclosure also describes techniques for controlling the bandwidth competition between the reliable transmission of the essential data and the unreliable, real time delivery of the enhanced data. For an essential data flow, the techniques utilize a controlled TCP (cTCP) scheme (a variant of TCP) to support application-level rate control. For an enhanced data flow, the techniques utilize a rate-control UDP (rUDP) protocol to regulate the unreliable delivery. Combining cTCP and rUDP, the techniques are able to control the interactions between the two flows in a session. As a result, the video streaming techniques described herein may yield more stable and predictable performance, which can be critical in providing consistent and controlled video quality assurance to end users.

In one embodiment, a method comprises partitioning an encoded video into a first part and a second part, and transmitting the first part of the encoded video through a network using a first network protocol. The method further comprises transmitting the second part of the encoded video through the network using a second network protocol different from the first network protocol.

In another embodiment, a system comprises a server, a proxy server, and a client device. The server partitions an encoded video into a first part and a second part, and delivers the first part of the encoded video to the proxy server using a first network protocol and the second part of the encoded video using a second network protocol different from the first network protocol. The proxy server merges the first part and the second part to form a merged video stream, and delivers the merged video stream to the client device.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram of a delivery system that implements the proxy-assisted staggered two-flow video streaming techniques described herein.

FIG. 2 is a block diagram illustrating portions of FIG. 1 in further detail.

FIGS. 3-8 are graphs that illustrate exemplary simulation and experimental results for the described techniques.

### DETAILED DESCRIPTION

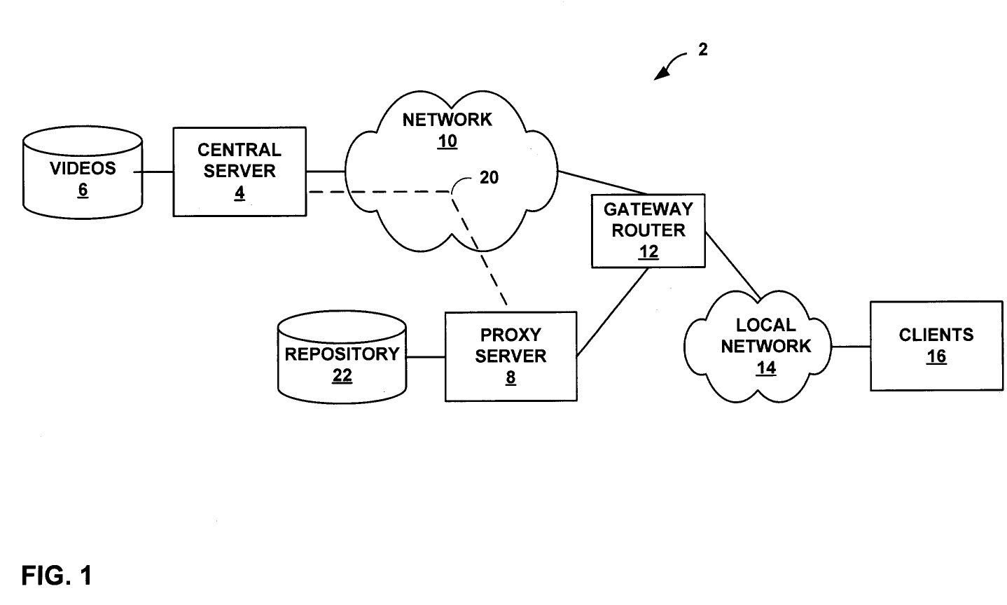

FIG. 1 is a block diagram of a proxy-assisted video delivery system 2. As illustrated, a central video server 4 provides access to a video repository 6 (“videos 6”). A proxy server 8 is coupled to network 10, typically attached to a gateway router 12 that couples a local access network 14 to network 10. Network 10 represents a wide-area backbone network, and operates as a best-effort network, such as the Internet. Proxy server 8 assists central server 4 in the distribution of stored videos to clients 16 dispersed within local access network 14. Exemplary clients 16 include desktop computers, laptop computers, digital televisions, mobile computing devices, personal digital assistants (PDAs), wireless communication devices, and the like.

The staggered two-flow video streaming technique described herein emphasizes controlled quality assurance for videos delivered across wide-area best-effort network 10. In accordance with the techniques, the videos from central server 4 are transmitted across network 10 to proxy server 8 through a VPN pipe 20.

According to the techniques, proxy-assisted video delivery system 2 makes use of inherent priority structures within encoded videos 6, e.g., an inter-frame dependence. Utilizing the priority structures in a video, for example, the techniques partition the video into an “essential” part and an “enhanced” part. Proxy server 8 reliably prefetches the essential part via VPN pipe 20, and caches the essential part within repository 22. The enhanced part that is “unreliably” transmitted over best-effort network 10 in real time via the same VPN pipe.

For example, MPEG encoded videos include a variety of frame types. Intra-coded frames (“I frames”) use encoding to compress a single video frame without reference to any other frame in the video sequence. In other words, each I frame is encoded independently from the other frames in the video sequence. According to the techniques, this type of frames are treated as “essential,” and prefetched via proxy server 8.

In contrast, predicted frames (“P-frames”) are coded as differences from the preceding I frame or P frame. Specifically, a new P-frame is first predicted by taking the preceding I or P frame and “predicting” the values of each new pixel of the frame. The differences between the predicted values and actual values are encoded as the P-frame. As a result, P-frames will typically give a compression ratio better than I-frames depending on the amount of motion present in the video. Similarly, bidirectional frames (“B-frames”) are coded as differences from either the preceding or subsequent I or P frame. According to the techniques, these types of frames are dependent upon other frames for the encoding, and are treated as the “enhanced” part of the video, and are not prefetched. Specifically, the enhanced part is unreliably transmitted in real time via the same VPN pipe 20.

To meet the timing constraint of the essential part, proxy server 8 pre-stores a prefix of the essential part, i.e., prior to a request by one of clients 16, and prefetches the remainder of the essential part on-demand using a reliable flow. The enhanced part is delivered using an unreliable flow which is adjusted based on the available bandwidth of VPN pipe 20, and the requirement of the reliable flow. Proxy server 8 merges the two flows in a session and delivers the merges flows as a video stream to the requesting one of clients 16.

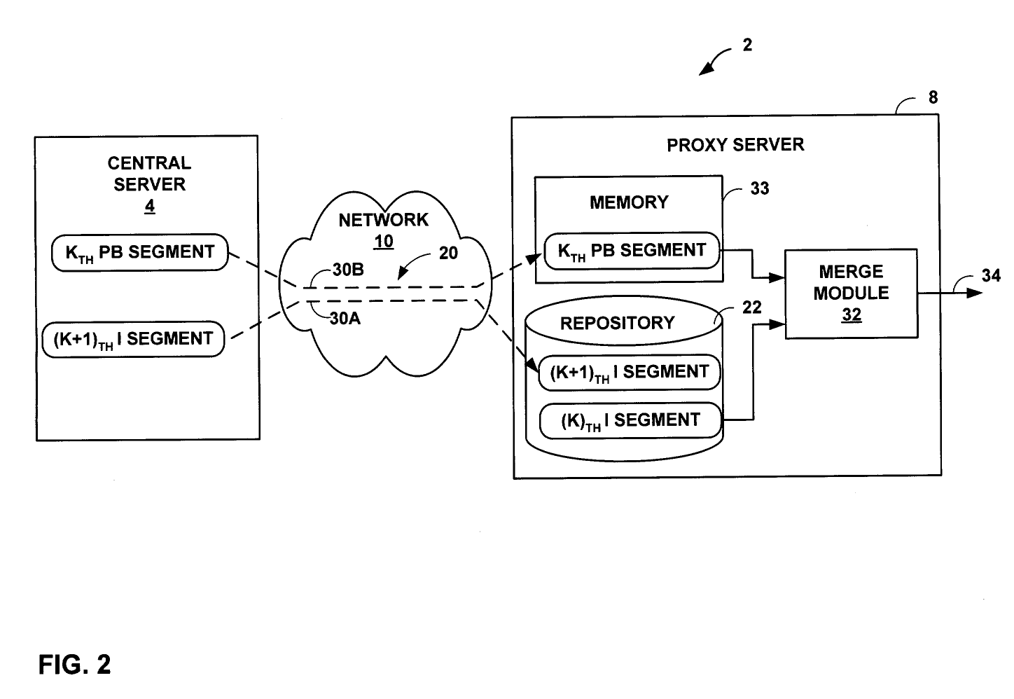

FIG. 2 is a block diagram illustrating portions of FIG. 1 in further detail. For exemplary purposes, the techniques are described in reference to the MPEG encoding scheme developed by the Moving Picture Experts Group. The techniques, however, are not so limited. Other exemplary encoding schemes include QuickTime™ technology developed by Apple Computer of Cupertino Calif., Video for Windows™ developed by Microsoft Corporation of Redmond, Wash., Indeo™ developed by Intel Corporation, and Cinepak™ developed by SuperMac Inc. Moreover, the techniques may readily be applied to other types of media, including audio streams.

In general, central server 4 divides each MPEG video into two sub-streams 30A, 30B (referred to herein as “flows 30”). Flow 30A contains the essential I frames that are intra-frame coded. The other flow 30B contains the less essential P/B frames that depend on the I frames, and possibly other P frames. As described in further detail herein, the I frame flow 30A is transmitted reliably, e.g., using cTCP, across the best-effort network 10, hence it is also referred to herein as the “reliable flow.” The P/B frame flow 30B is transmitted unreliably in real-time, e.g., using rUDP, across network10, hence it is also referred to herein the “unreliable” flow. Central server 4 may partition the data in both flows 30 into relatively large video segments with equal length, e.g., as measured in time. To take advantage of storage space of proxy server 8, i.e., repository 22, the first segment of the reliable flow is staged, i.e., pre-stored, at the proxy server. To reduce the start-up latency, the techniques also pre-store a small pre-fix of the unreliable P/B frame flow at proxy server 8.

When one of clients 16 requests a video at proxy server 8, the first segment of the unreliable (P/H frame) flow is delivered unreliably in real-time from central server 4 to the proxy server. As the P/B frames in this segment are received, merge module 32 of proxy server 8 merges them with the appropriate I frames that are retrieved from repository 22 where the first segment of the reliable flow is pre-stored. Proxy server 8 delivers the merged video stream 34 to the requesting client 16.

While the first segment of the unreliable flow is being transmitted to the requesting client 16, the second segment of the reliable flow is also being delivered from central server 4 to proxy server 8 and cached within proxy cache, e.g., memory 33, as it is not needed immediately. This process continues until the entire video is delivered to the requesting client 16. In this manner, the techniques ensure that the video segments of the reliable and unreliable flows of a video are delivered in a staggered manner: for k=1; 2; : : :, the kₜₕ video segment of the unreliable flow is transmitted at the same time as the (k+1)ₜₕ video segment of the reliable flow is delivered from central server 4 to proxy server 8. Note that since the reliable flow is delivered one segment ahead of time as it is needed, there is sufficient time to recover any lost packets in the reliable flow during the period, e.g., through TCP retransmission. In this way, the techniques ensure that all I frames are prefetched reliably from across the best-effort network 10. This is in contrast to the transmission of the segments of the unreliable flow, which are delivered in real-time.

Given the capacity of VPN pipe 20 and proxy server 8, the described techniques can achieve a flexible control of quality assurance. The techniques can provide various service assurances by applying different partition schemes for diverse user requirements. For example, the techniques show one way of partitioning a MPEG video in the above discussion. However, the techniques can also divide the same video in other manners, and apply different partition policies on videos based on demand.

Since both the reliable flow 30A and the unreliable flow 30B of a video may follow the same path through network 10, they potentially compete for the bandwidth along the path. Techniques are described to control the interaction between the two flows 30 and, in particular, to reduce the retransmissions in the reliable flow 30A and the packet losses experienced by the unreliable flow 30B. This may becomes especially advantageous when multiple videos are streamed through the same VPN pipe 20. To address this, the techniques introduce cTCP and rUDP, described below, for controlling reliable flow 30A and unreliable flow 30B with application bandwidth requirements, respectively, in order to avoid blind bandwidth competition as regular transport protocols.

In particular, a cTCP scheme is described with application-aware rate control for transmitting reliable flow 30A of a video, and a rUDP scheme is described for regulating the delivery of unreliable flow 30B as near CBR. One objective in designing cTCP and rUDP is to attain some controllability and predictability in data transmission. In particular, the techniques exert some degree of control on the interaction of reliable flow 30A and unreliable flow 30B of various video sessions sharing VPN pipe 20 in order to provide consistent and controlled video quality assurance to clients 16.

In general, the techniques described herein extend the TCP protocol with an application-level rate control mechanism to transmit a reliable flow. If sufficient bandwidth along VPN pipe 20 is available, each segment of reliable flow 30A can be delivered across network 10 before its deadline. However, directly applying TCP for transmitting reliable flow 30A has some undesirable effects. First, the greedy increase of the injection rate of a TCP flow causes unnecessary packet drops even when sufficient network resources are given. Assume unreliable flow 30B is an UDP CBR flow, and reliable flow 30A is delivered using TCP. A TCP flow uses an additive increase and multiplicative decrease (AIMD) algorithm in its flow control, which attempts to maximize its throughput by injecting as many packets as the network allows, and enters into a steady state that oscillates with periodic packet losses.

This greedy behavior unfortunately has an adverse effect on both reliable flow 30A and unreliable flow 30B. Even when the available bandwidth is sufficient for transmitting both flows 30 during a video segment period, a TCP flow grabs more bandwidth than what it needs, transmitting its data in a blast. As a result, unreliable flow 30B suffers more packet losses, and reliable flow 30A suffers more retransmissions. This problem is further compounded when multiple video streams share the same VPN pipe 20. Furthermore, TCP flows tend to share the available bandwidth more or less equally, while the bandwidth requirements of reliable flow 30As of various video streams are different. As new video streams are initiated or existing video streams are terminated, the bandwidth shares of the TCP flows are also fluctuated unnecessarily, independent of their actual bandwidth requirements.

To address these issues, the techniques develop controlled TCP (cTCP) to control the bandwidth shares of reliable flows. The techniques leverage the fact that in delivering each video segment in a reliable flow, only the amount of bandwidth that is sufficient to transmit the video segment before its deadline is needed. More bandwidth for reliable flow 30A is not necessary, and may even be harmful to both flows 30 in a session.

Hence, given a sufficient bandwidth, the techniques limit the TCP injection rate for a video segment

$$\frac{S}{T ( 1 - \hat{p} )}$$

to the needed amount. This leads to the concept of the target rate of a video segment: Given a video segment of length T (measured in seconds), let S be its data size (measured in bytes), then its target rate, denoted as target T_{cTCP}, is given by (bytes/sec), where \hat{p} is the cTCP retransmission threshold, e.g., 0:05. The factor 1/(1−\hat{p}) accounts for the potential bandwidth consumed by retransmissions in a network with a packet loss rate of at most \hat{p}. TCP uses a window-based flow control mechanism, where the number of outstanding packets that can be injected into the network is limited by a window W=min(W_{cwnd}, W_{recv}), where W_{cwnd} is the congestion window size, and W_{recv} is the receiver window size.

To limit the rate of a TCP connection, the techniques let W=min(W_{cwnd}; W_{recv}; W_{target}), where W_{target} is the target injection window size computed based on T_{cTCP}, RTT and packet loss information using a TCP throughput model. Note that the receiver of reliable flow 30A is proxy server 8, which is assumed to have sufficient receiving buffer space to accommodate the data of reliable flow 30A before writing the data into its storage. Ignoring W_{recv} from the above formula it is determined that when W_{target}<W_{cwnd}, the rate of a TCP connection is limited by W_{target}, even though more packets can be injected into the network without causing congestion. When W_{target}>W_{cwnd}, the rate is determined by the congestion window W_{cwnd}, as is in the regular TCP. A relatively simple TCP throughput model can be used to estimate W_{target}. More sophisticated TCP models can be used to further improve the accuracy.

When there are small packet losses, the steady state TCP rate is given approximately by the simple formula 0:75·W·MSS/RTT, where MSS is the TCP maximal segment size in a packet, and RTT is the smoothed round trip time. When there is no packet losses, the TCP rate is roughly W·MSS=RTT. Based on this model, W_{target} can be computed from a given target T_{cTCP} as follows: W_{target}=(T_{cTCP}·RTT)=(0:75·MSS), if there are packet losses; W_{target}=(T_{cTCP}·RTT)=MSS, otherwise. Note that in using the above model to compute W_{target}, the techniques call for the measurement of RTT and the packet losses. To take possible changes of RTT and packet losses into account, W_{target} can be periodically adjusted after each adjustment interval, during the transmission of a video segment of reliable flow 30A. Compared to RTT, which is usually 0.1 second or less, the adjustment interval, e.g., 8 seconds, is fairly larger, yielding the stable evolution of W_{target}. The following pseudo-code illustrates adjustment codes in a cTCP implementation:

//At the end of each adjustment interval,
//p is the reference to the control block.
//Choose the constant based on loss status.
loss_ = (p−>curr_pkt_loss) ? 75 : 100;
//Reset packet loss for next interval
p−>curr_pkt_loss = 0;
// Compute the target window
p−>target win = p−>target rate * 100 _{—}

(p−>ctcp_srtt >> cTCP_RTT_SHIFT) / loss_ * hz);

To control the delivery of unreliable real-time flow 30B in a video session, the techniques regulate the flow as a piecewise CBR traffic. In particular, the techniques the standard UDP protocol with a periodical injection mechanism and a buffer to achieve this requirement. Central server 4 utilizes a fine-grain timer is used to periodically inject small bursts of UDP data from the buffer into network 10. Central server 4 combines the timer with a leaky-bucket regulator to limit the injection rate of a rUDP flow to a linear bound.

In one embodiment, central server 4 sets the token rate of the leaky-bucket as the target rate of a rUDP flow, which is a CBR. In addition, central server 4 may determine the burst size of a rUDP flow based on a number of tokens accumulated since the last timeout. The timeout granularity, the target rate, and the buffer size can be dynamically adjusted by central server 4 or an administrator. When central server 4 attempts to write to the buffer which is already full, it is blocked until the buffer becomes available again.

The techniques extend the IP Protocol Control Block to keep the state information of a rUDP flow. By combining cTCP and rUDP, the techniques are able to reduce the number of retransmissions in reliable flow 30A and the number of packet drops in unreliable flow 30B, and provide more predictable overall system performance in data transmission.

### EXAMPLES

A number of simulations are described. For convenience, a reliable flow that is transmitted using cTCP is referred to a cTCP flow, and a reliable flow that is transmitted using regular TCP is referred to as a TCP flow. Similarly, an unreliable flow that is transferred using RTP/rUDP is referred to as a rUDP flow. A video stream that has a cTCP flow and a rUDP flow is referred to as a cTCP/rUDP session, and a video stream that has a TCP flow and a rUDP flow is referred to as a TCP/rUDP session.

These examples, the techniques demonstrate that: 1) cTCP indeed provides us with the ability to control the bandwidth sharing among reliable flows; 2) combining cTCP and rUDP, the techniques significantly reduce the number of packets retransmitted and dropped in both flows. Therefore, the techniques may yield more stable and predictable performance that is critical in providing controlled video quality assurance to clients 16.

Simulations were implemented using Network Simulator (NS2), where central server 4 and proxy server 8 coupled by VPN pipe 20 having a capacity C were simulated. The actual value of C depends on a specific simulation scenario. The buffer size of VPN pipe 20 was determined based on the link capacity, and in such a manner that the maximum queueing delay for the pipe was 50 ms. The propagation delay of VPN pipe 20 was set to 40 ms. The network MTU was set to be 1500 bytes. All data packets are assumed to be the same size, with a payload of 1460 bytes. The target-window adjustment interval used in cTCP was 8 seconds.

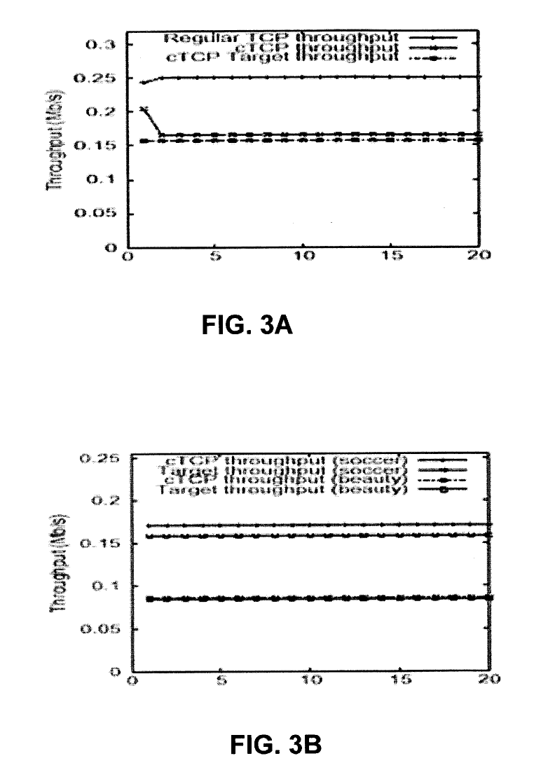

In the first set of simulations, the effectiveness of the application-level rate control in cTCP was illustrated. Hence in this set of simulations, only reliable flows were considered. The link capacity C was set to 0.256 Mbps. FIG. 3A is a graph that shows the rates when a cTCP or a TCP flow was used to transmit reliable flow 30A of a video trace “Soccer” in VPN pipe 20. In this simulation, reliable flow 30A has a target rate of 0.158 Mbps. FIG. 3A shows that the cTCP flow attains a stable rate close to its target rate, whereas the TCP flow grabs almost all the available bandwidth, attaining a rate close to the link capacity. The x-axis in FIG. 3A represents time, indexed by the adjustment intervals.

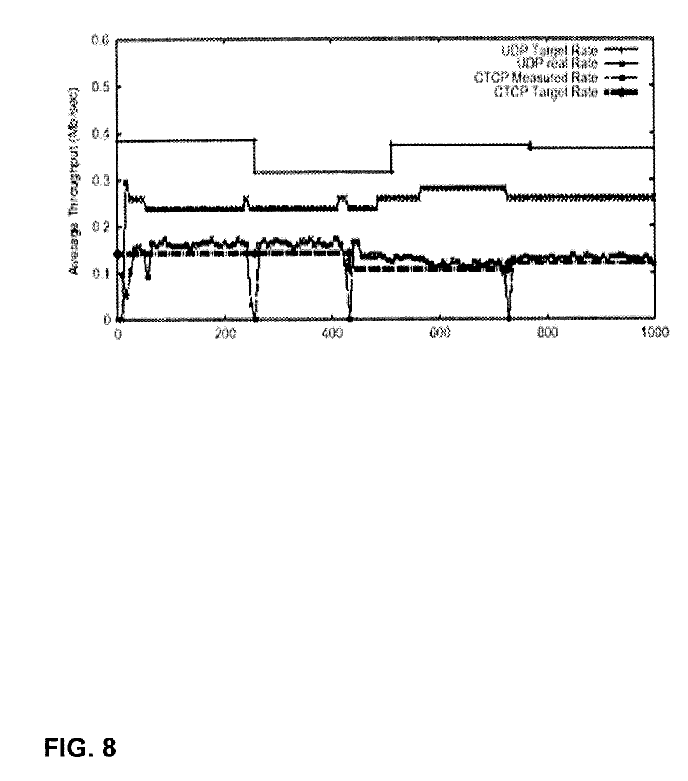

FIG. 3B is a graph that shows the rates when two cTCP flows 30A share the same VPN pipe 20, with target rates of 0.158 Mbps from video trace Soccer and 0.085 Mbps from a video trace “Beauty and Beast,” respectively. In this simulation, the sum of the target rates was less than the bottleneck link capacity. In this case, each cTCP flow 30A attains a stable rate which was close to its target rate, as illustrated in FIG. 3B. This was opposed to the situation when the flows are transmitted using regular TCP: the bottleneck link capacity was shared equally between both flows, regardless of their requirements, similar to FIG. 8B. The results illustrated in FIGS. 3A, 3B show that when the link capacity of VPN pipe 20 was larger than the total target bandwidth requirement of all reliable flows 30A, the cTCP scheme was effective in controlling the bandwidth sharing among reliable flows 30A.

The next simulations illustrate the interaction between reliable flows 30A and unreliable flows 30B and, in particular, the impact of cTCP or TCP flows on packet losses experienced by unreliable flows 30B and packet retransmissions in reliable flows 30A. It was still assumed that the aggregate bandwidth of VPN pipe 20 was sufficient to satisfy the total bandwidth requirement of all of the video streams, including all reliable and unreliable flows currently sharing VPN pipe 20.

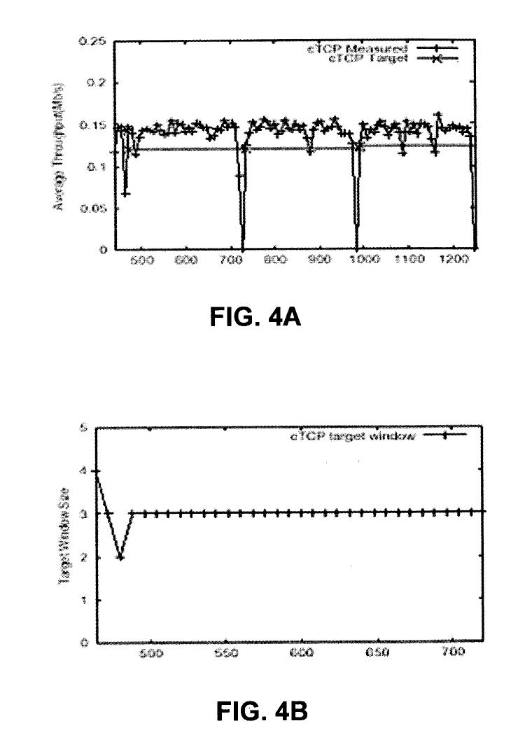

FIG. 4A is a graph that illustrates the results of delivering a single video stream across VPN pipe 20 using the proposed technique. The video trace used in this simulation was an approximately 100 minute long sequence from the MPEG-1 encoded move Star Wars, with a frame rate of 24 frames/s and a GOP pattern of 12 frames (IBBPBBPBBPBB). The video stream was divided into a reliable flow (containing 12800 I frames) and an unreliable flow (containing 140800 P/B frames). Both flows were partitioned into segments with a length of 256 seconds. The total average bandwidth requirement of the two flows together was 0.495 Mbps, the total maximum bandwidth requirement was 0.529 Mbps. In this simulation, the bottleneck link capacity was set to 0.529 Mbps, i.e., equal to the total maximum bandwidth requirement of the two flows. In addition, unreliable flow 30B was assumed to start 8 seconds (an adjustment interval) later than reliable flow 30A allowing cTCP to obtain the initial RTT measurement and set W_{target}. This delay in starting the rUDP flow 30B was masked by caching a small prefix of unreliable flow 30B at proxy server 8.

FIG. 4A shows the measured rate (the y-axis) of the cTCP flow during the transmission of the third, fourth, and fifth segments of the video. As illustrated, the cTCP flow 30A meets the delivery deadline of each segment and attains a stable rate close to the target rate of each segment. In particular, the third, fourth, and fifth I segments were delivered, respectively, by the 720th, 967th, and 1248th second, all ahead of their respective deadlines (the 768th, 1024th, and 1280th second). Note that the measured cTCP rate dips at the end of each segment because the transmission of the segment was completed. The P/B segments of the rUDP flow 30B were also delivered smoothly with only a few packet losses.

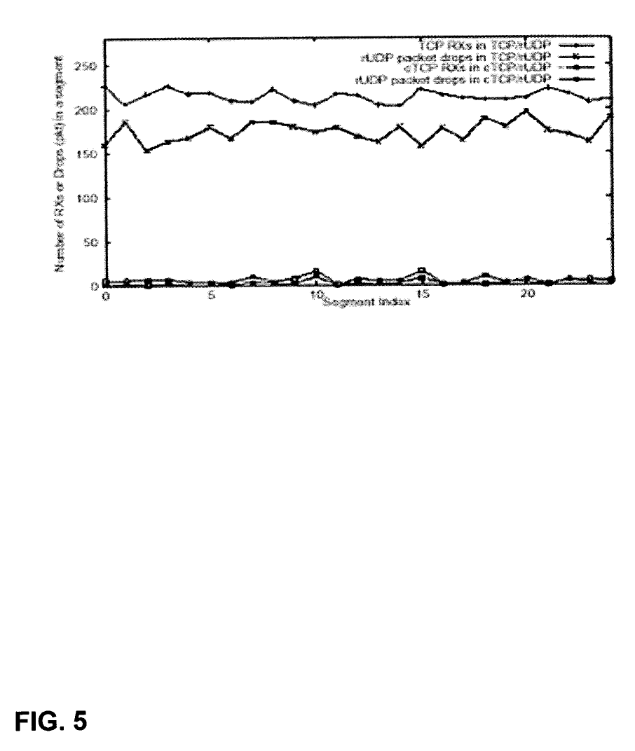

FIG. 5 is a graph in which the bottom two lines illustrate the numbers of cTCP packet retransmissions as well as that of rUDP packet losses during the transmission of the entire session. The x-axis represents the index of video segment. As illustrated, the cTCP flow 30A only experienced a small number of packet retransmissions in each video segment. The cTCP flow 30A reached a steady state with a stable W_{target}, as illustrated in FIG. 4B. After that, the cTCP flow 30A injects the packets into the network at a steady pace. Sharing the RTT from an existing connection between central server 4 and proxy server 8 may help the cTCP flow 30A skip the slow-start learning curve and reach a steady state directly. Because the cTCP flow 30A grabs only the bandwidth it needs, the corresponding rUDP flow 30B obtains sufficient bandwidth for its transmission. As a result, it experiences only a few packet losses, due to the limit of timer resolution of the OS used in the RTT estimation. This was in contrast with the scenario where reliable flow 30A was transmitted using regular TCP, as was shown in the upper part of FIG. 5. Due to the greediness of TCP, both the TCP flow and rUDP flow 30B experience rather large numbers of losses or retransmissions during the transmission of each segment.

The next simulations further demonstrate the advantage of cTCP over regular TCP, and illustrate the packet losses experienced by both reliable flows 30A and unreliable flows 30B when multiple video sessions of Star Wars were transmitted over VPN pipe 20. In this set of simulations, the bottleneck link capacity was set to be the same as the total maximum bandwidth required by all concurrent sessions, and each video session starts randomly within a short period of time.

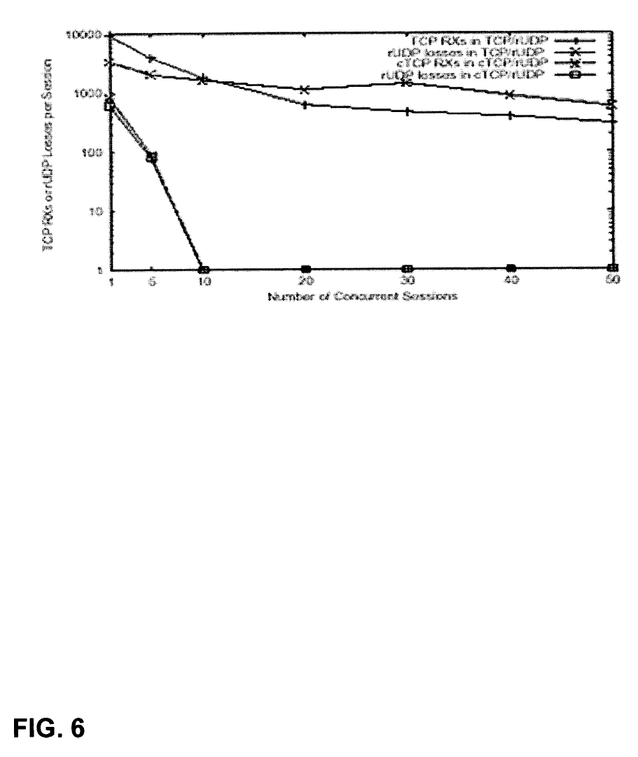

FIG. 6 is a graph that illustrates that, with sufficient bandwidth, a cTCP/rUDP session has no packet losses when the number of sessions was equal to or more than 10, while a TCP/rUDP session always has large numbers of TCP retransmissions and rUDP packet losses. Because of the controlled bandwidth sharing of the cTCP flows, there was always sufficient bandwidth for the rUDP flows to transmit their packets. When the bottleneck link capacity of VPN pipe 20 is slightly higher than (e.g., 1.1 times or more) the total maximum video rate requirement, cTCP/rUDP sessions can achieve no packet drops and retransmissions in almost all cases, while TCP/rUDP sessions still have large numbers of packet drops and retransmissions.

The next simulations illustrate the potential effect of rUDP packet drops on the user perceived video quality. For a given video session, let E_{f} denote the number of P/B frames that were affected by packet losses (i.e., at least one packet of the frame was lost during the transmission), and E_{g} was the number of GOPs that have at least one a affected P/B frame. Moreover, the techniques use G_{avg} and Gₘₐₓ to denote, respectively, the average number of affected P/B frames per affected GOP, and the maximum number of affected P/B frames per affected GOP, computed among all affected GOPs. Similarly, the techniques use

$${G}_{avg}^{′ c on}$$

and

$${G}_{max}^{′ c on}$$

to denote, respectively, the average number of consecutive affected P/B frames per affected GOP, and the maximum number of consecutive affected P/B frames per affected GOP, again computed among all affected GOPs.

$${G}_{total}^{′ c on}$$

denotes the total number of consecutive affected P/B frames across all affected GOPs. Table I illustrates these metrics for the regular TCP/rUDP video sessions, where the results were obtained by averaging over all the TCP/rUDP sessions, where n was the number of sessions.

TABLE I
Affected P/B frames of a rUDP flow in a TCP/rUDP session.

| n | E_{f} | E_{g} | Gₘₐₓ | G_{avg} | Gₜₒₜₐₗ^{con} | Gₘₐₓ^{con} | G_{avg}^{con} |
|---|---|---|---|---|---|---|---|
| 1 | 2862 | 2365 | 5 | 1.2 | 139 | 3 | 2.0 |
| 5 | 4856 | 3799 | 5 | 1.3 | 282 | 3 | 2.1 |
| 10 | 6501 | 4605 | 5 | 1.4 | 519 | 4 | 2.1 |
| 20 | 8971 | 5594 | 7 | 1.6 | 848 | 5 | 2.1 |
| 50 | 6196 | 4530 | 6 | 1.4 | 379 | 5 | 2.1 |

In contrast, Table II illustrates the corresponding results of cTCP/rUDP video sessions.

TABLE
Affected P/B frames of a rUDP flow in a cTCP/rUDP session.

| n | E_{f} | E_{g} | Gₘₐₓ | G_{avg} | Gₜₒₜₐₗ^{con} | Gₘₐₓ^{con} | G_{avg}^{con} |
|---|---|---|---|---|---|---|---|
| 1 | 617 | 541 | 2 | 1.0 | 9 | 2 | 1.0 |
| 5 | 356 | 380 | 2 | 1.0 | 5 | 2 | 1.0 |
| 10 | 0 | 0 | 0 | 0 | 0 | 0 | 0.0 |
| 20 | 0 | 0 | 0 | 0 | 0 | 0 | 0.0 |
| 50 | 0 | 0 | 0 | 0 | 0 | 0 | 0.0 |

As illustrated, cTCP/rUDP sessions outperform TCP/rUDP sessions in each category, especially in the total number of consecutive affected frames and the maximum number of consecutive affected frames which potentially cause the worst damage to playback quality. Again, given a slightly higher bottleneck capacity on VPN pipe 20, cTCP/rUDP sessions can achieve no packet drops or retransmissions. In this case, all the entries in Table II will be zero. Under the same conditions, TCP/rUDP sessions will have similar behavior as shown in Table I.

The final set of simulations show the effect of dynamic session arrivals and departures on a cTCP/rUDP or a TCP/rUDP session. In these simulations the techniques set the bottleneck link capacity of VPN pipe 20 to 1.1 times of what was needed to carry five concurrent video sessions of Star Wars. At the beginning, the simulations had four ongoing video sessions; then at video segment 10 (i.e., after 2560 seconds), a new video session was started to join the four on-going video sessions; at segment 13 (i.e., after 3328 seconds), two video sessions were terminated.

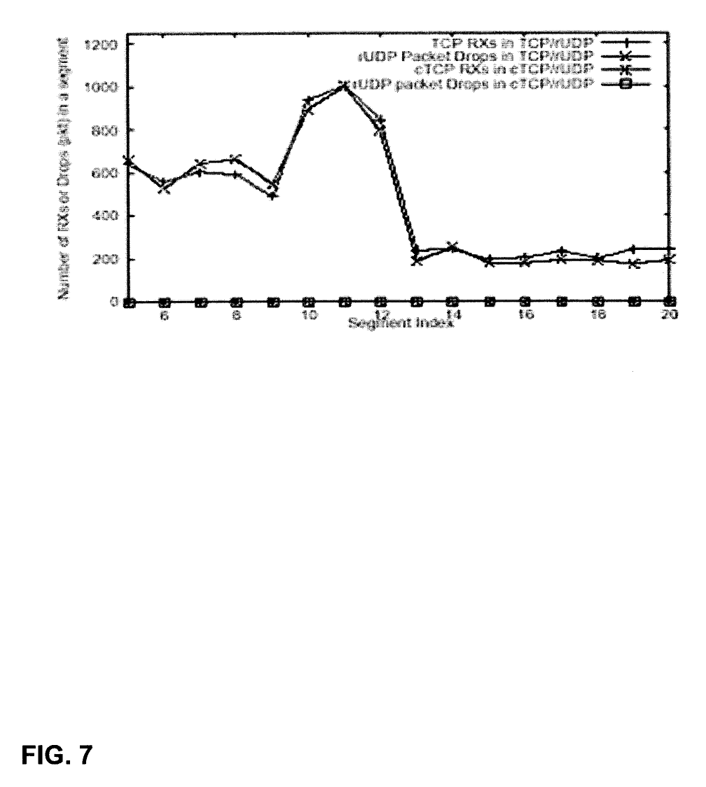

FIG. 7 is a graph that shows the impact of the session arrivals and departures on the packet losses and retransmissions experienced by a session: the bottom two curves in FIG. 7 represent a cTCP/rUDP session, while the upper two curves represent a TCP/rUDP session. As illustrated, the dynamic session arrivals and departures have no visible impact on the ongoing cTCP/rUDP session in this case. In contrast, they have a strong impact on both packet retransmissions and drops in the TCP/rUDP session. This is because TCP always attempts to distribute the bandwidth equally among the TCP flows of the current ongoing sessions. When a new video session joins or an existing session leaves, the available bandwidth has to be redistributed among the TCP flows. These fluctuations cause the packet retransmissions and drops experienced by the video sessions, and therefore induce fluctuations in the video quality perceived by clients 16. Combining cTCP and rUDP, the techniques were able to avoid the fluctuations, therefore providing more consistent video quality to clients 16.

An application-aware admission control scheme may be used to ensure that VPN pipe 20 has sufficient bandwidth for cTCP flows to share. Because the performance predictability of cTCP and rUDP provides us the chance of performing a form of application-aware rate control at either proxy server 8 or a central server 4, the techniques can ensure that the total bandwidth requirement of all video sessions carried by a VPN pipe was less than the bottleneck capacity of the pipe.

Assume that the aggregate bandwidth of VPN pipe 20 was guaranteed and known via a service level agreement. Proxy server 8 only allows a new video session to be carried over the VPN if its maximum bandwidth requirement of both the reliable and unreliable flows 30 is less than the residual bandwidth on the VPN. Here the residual bandwidth was the difference between the capacity of VPN pipe 20 and the total bandwidth requirement of the ongoing video sessions. In the case where the aggregate bandwidth of VPN pipe 20 is not guaranteed, measurement-based techniques may be applied. In particular, the measured rates of both cTCP flows and rUDP flows as well as the measured packet losses of these flows may be used as the criteria to determine whether a new video session can be admitted. If their measured rates of the flows are close to their corresponding target bandwidth requirements, and the measured packet losses were significantly below preset packet loss thresholds for both cTCP flows and rUDP flows (e.g., 0.05), the new video session is then admitted. Otherwise it is rejected.

FIG. 8 is a graph that illustrates the effect of the rate adaptation techniques in a simple simulation. A cTCP/rUDP video session of Star Wars was carried over VPN pipe 20 with a bottleneck capacity C of 0.4 Mb/s. The average bandwidth requirement of the video session (including both flows) was 0.495 Mb/s, larger than C. The average rate of the cTCP flow 30A was 0.134 Mb/s, smaller than C. FIG. 14 shows the measured rates of both the cTCP flow 30A and the rUDP flow 30B during the first 1000 seconds of the session, as well as their target rates. Because the rUDP flow 30B reduced its transmission rate (lower than its target rate), the cTCP flow 30A was able to attain its target rate. Note, the dips in measured cTCP throughput were due to the end of I segment transmission.

Various embodiments have been described. In particular, a staggered two-flow video streaming technique has been described to provide controlled quality assurance in delivering videos across a wide-area best-effort network. The techniques utilize the priority structure in encoded videos. Moreover, techniques have designed cTCP and rUDP with application-aware rate-control for the reliable and timely delivery of the essential data and the enhanced data of videos.

The described techniques can be embodied in a variety of computing devices, including, laptop computers, handheld computing devices, personal digital assistants (PDA's), and the like. The techniques may carried out by a programmable processor or other hardware, such as a general-purpose processor, a digital signal processor (DSP), a field programmable gate array (FPGA), an application specific integrated circuit (ASIC) or similar hardware, firmware and/or software. If implemented in software, a computer readable medium may store computer-readable instructions, i.e., program code, that can be executed by a processor to carry out one of more of the techniques described above. For example, the computer-readable medium may comprise random access memory (RAM), read-only memory (ROM), non-volatile random access memory (NVRAM), electrically erasable programmable read-only memory (EEPROM), flash memory, or the like. The computer-readable medium may comprise computer-readable instructions that when executed in a wireless communication device, cause the wireless communication device to carry out one or more of the techniques described herein. These and other embodiments are within the scope of the following claims.

1. A method comprising:
partitioning an encoded video into a first part and a second part;
transmitting the first part of the encoded video through a network using a first network protocol; and
transmitting the second part of the encoded video through the network using a second network protocol different from the first network protocol.

2. The method of claim 1, further comprising:
pre-storing a prefix of the first part on a proxy server, and prefetching the remainder of the first part with the proxy server in response to a client request using the first network protocol.

3. The method of claim 1, wherein transmitting the first part comprises transmitting the first part of the encoded video using a reliable network protocol, and transmitting the second part comprises transmitting the second part of the encoded video using an unreliable network protocol.

4. The method of claim 1, wherein transmitting the first part comprises transmitting the first part of the encoded video using application-level rate control, and transmitting the second part comprises transmitting the second part of the encoded video using a rate controlled network protocol.

5. The method of claim 1, wherein transmitting the first part comprises prefetching at least a portion of the first part of the encoded video, and transmitting the second part comprises transmitting the second part of the encoded video in real-time.

6. The method of claim 5, further comprising staggering the transmission of the first and second parts, by prefetching a (K+1)^{th} segment of the first part from a central server with a proxy server in parallel with transmitting a K^{th} second part to a client device.

7. The method of claim 1, wherein partitioning an encoded video comprises partitioning the encoded video based on priority structures of encoded frames of the encoded video.

8. The method of claim 7, wherein partitioning an encoded video comprises partitioning the encoded video into a first part that includes frames that are encoded independently from other frames of the video, and a second part that includes frames that are dependently encoded based on other frames of the video.

9. The method of claim 1, partitioning an encoded video comprises partitioning the encoded video into a first part that includes intracodced MPEG frames, and a second part that includes bidirectional frames and predicted frames.

10. The method of claim 1, further comprising:
receiving the first part and the second part with a proxy server via the first and second network protocols;
merging the first part and the second part to form a merged video stream; and
delivering the merged video stream to a client device.

11. A system comprising:
a server that partitions an encoded video into a first part and a second part;
a proxy server coupled to the server via a network, wherein the server delivers the first part of the encoded video to the proxy server using a first network protocol and the second part of the encoded video using a second network protocol different from the first network protocol; and
a client device coupled to the proxy server, wherein the proxy server merges the first part and the second part to form a merged video stream, and delivers the merged video stream to the client device.

12. The system of claim 11, wherein the proxy server pre-stores a prefix of the first part on a proxy server, and simultaneously delivers the prefix to the client device and prefetches the remainder of the first part from the server in response to a request from the client device.

13. The system of claim 11, wherein the central server transmits the first part of the encoded video using a reliable network protocol, and transmits the second part comprises of the encoded video using an unreliable network protocol.

14. The system of claim 11, wherein the central server transmits the first part of the encoded video using application-level rate control, and transmits the second part of the encoded video using a rate-controlled network protocol.

15. The system of claim 11, wherein the proxy server prefetches at least a portion of the first part of the encoded video from the server, and receives the second part of the encoded video from the server in real-time.

16. The system of claim 15, wherein the proxy server prefetches a (K+1)^{th} segment of the first part from the server in parallel with transmitting a K^{th} second part to the client device.

17. The system of claim 11, wherein the server partitions the encoded video to include in the first part frames of the encoded video that are encoded independently from other frames of the encoded video, and to include in the second part frames that are dependently encoded based on other frames of the video.

18. The system of claim 17, wherein the server partitions the encoded video to include in the first part intracodced MPEG frames, and to include in the second part bi-directional frames and predicted frames.

19. The system of claim 11, wherein the server partitions the encoded video based on priority structures of encoded frames of the encoded video.

20. A computer-readable medium comprising instructions for causing a programmable processor to:
partition an encoded video into a first part and a second part;
transmit the first part of the encoded video through a network using a first network protocol; and
transmit the second part of the encoded video through the network using a second network protocol different from the first network protocol.

21. The computer-readable medium of claim 20, further comprising instructions to:
transmit the first part of the encoded video using a reliable network protocol; and
transmit the second part comprises transmitting the second part of the encoded video using an unreliable network protocol.

22. A method comprising transmitting an encoded video using an application-level rate controlled reliable network protocol by controlling a transmission rate of the reliable network protocol based on settings received from application-level software.
